(19) United States
(12) Patent Application Publication
(10) Pub. No.: US 2025/0040491 A1
(43) Pub. Date: Feb. 6, 2025

(54) Non-Arch-Shaped Rainproof Water-Collection Greenhouse

(71) Applicant: Yixian ZENG, Zhangzhou (CN)

(72) Inventor: Yixian ZENG, Zhangzhou (CN)

(21) Appl. No.: 18/927,882

(22) Filed: Oct. 26, 2024

Related U.S. Application Data
(63) Continuation of application No. PCT/CN2023/078131, filed on Feb. 24, 2023.

(30) Foreign Application Priority Data
Feb. 26, 2022 (CN) 202210235216.0

(51) Int. Cl. A01G 9/14; E04D 13/04

(52) U.S. Cl. CPC A01G 9/1476; A01G 9/1407; A01G 9/1438; E04D 13/0409; A01G 2009/1446; A01G 2009/1453; E04D 2013/0495

(57) ABSTRACT

The present invention relates to a non-arch-shaped rainproof water-collection greenhouse, characterized by: a matrix of upright galvanized steel pipe columns, with adjacent columns fixed by cables connected to their upper ends, forming cable grids. A square greenhouse film with support rods along its edges is installed onto these cable grids. A water-collecting funnel and collection bucket are mounted at the center of the square film. The weight of the collection bucket and rainwater causes the square film to sag into a conical shape. To prevent excessive sagging or tearing, sag-limiting ropes are attached from the top ends of the four steel pipe columns corresponding to the film's corners, supporting the film from below and suspending the funnel and bucket in midair, creating a smooth, controlled sag. This invention features a rational design, simple structure, and minimal steel usage.

### CROSS-REFERENCE TO RELATED APPLICATION

This application is a continuation of International Application No. PCT/CN2023/078131, filed on Feb. 24, 2023, which claims priority to Chinese Patent Application 202210235216.0, filed on Feb. 26, 2022. All of the aforementioned applications are incorporated herein by reference in their entireties.

### TECHNICAL FIELD

This invention relates to agricultural production facilities, specifically a non-arch-shaped greenhouse.

### BACKGROUND OF THE INVENTION

Currently, agricultural greenhouses primarily consist of arch frames covered with film, where the frame is constructed from multiple parallel metal rods, each comprising two upright sections connected by an arcuate section at the top. The major disadvantages of such a structure include: (1) the use of more steel due to the curved sections, leading to higher construction costs; (2) poor wind resistance, resulting in easy damage to the film and high maintenance costs; and (3) inability to collect rainwater.

### SUMMARY OF THE INVENTION

In view of the limitations of existing technology, this invention aims to provide a non-arch-shaped rainproof water-collection greenhouse with a reasonable design that significantly reduces steel usage.

The non-arch-shaped rainproof water-collection greenhouse comprises galvanized steel pipe columns arranged in a matrix configuration. Adjacent columns are fixed in place by cables attached to their upper ends, forming a cable matrix. A square greenhouse film with edge support rods is mounted onto the cable matrix. The square greenhouse film includes a central drainage hole for rainwater, which leads to a water-collecting funnel connected to a collection bucket, causing the film to sag slightly inwards due to weight. The upper ends of the galvanized steel pipe columns corresponding to the four corners of the square greenhouse film are attached to the first ends of film sag-limiting ropes, the second ends of which connect to the water-collecting funnel. These ropes hold the square film from below and suspend the collection bucket, limiting the film's sagging depth. The film sag-limiting ropes are preferably elastic.

Additionally, the edges of the square greenhouse film have hemmed strips that fold back towards the center, forming passages for the insertion of film support rods.

The square greenhouse film may be made of canvas, tarpaulin, oilcloth, or plastic, while the support rods may be metal, plastic, or fiberglass.

The drainage hole connects to a funnel with a conical shape, whose lower wall is adhesively attached to the edge of the drainage hole.

The lower opening of the funnel connects to a collection bucket equipped with either a first drainage pipe on the side or a second drainage pipe with a switch valve at the bottom.

Since this greenhouse only uses galvanized steel pipe columns, eliminating the need for curved sections, it saves on steel materials and reduces construction costs.

### BRIEF DESCRIPTION OF DRAWINGS

FIG. 1 is a top view of the invention;

FIG. 2 is a front view of the square greenhouse film;

FIG. 3 is a sectional view of the film's edge portion;

FIG. 4 is a schematic view of the structure between adjacent galvanized steel pipe columns;

FIG. 5 is an enlarged view of a part of FIG. 4;

FIG. 6 illustrates an alternative embodiment of FIG. 5; and

FIG. 7 illustrates another alternative embodiment of FIG. 5.

### DETAILED DESCRIPTION OF THE INVENTION

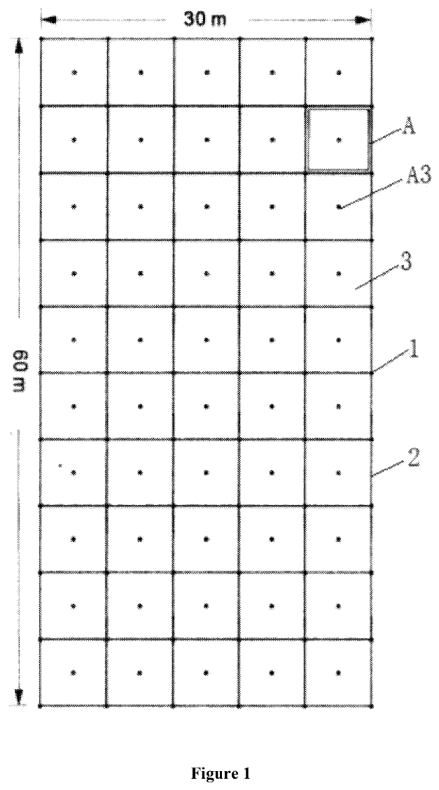

The greenhouse includes galvanized steel pipe columns (1) arranged in a matrix. The spacing between adjacent columns can range from 3 to 8 meters, with 6 meters being optimal. FIG. 1 illustrates a 60-meter by 30-meter plot, where each column is spaced 6 meters apart.

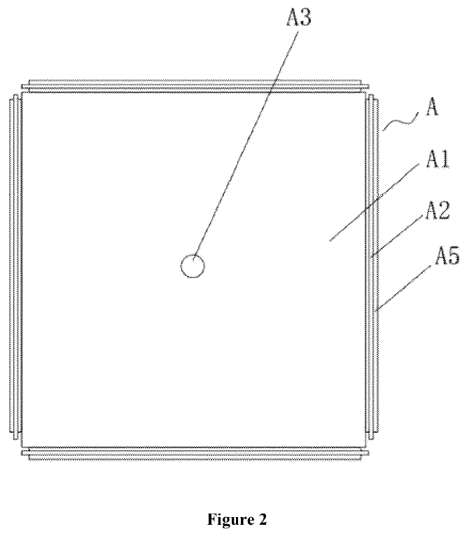

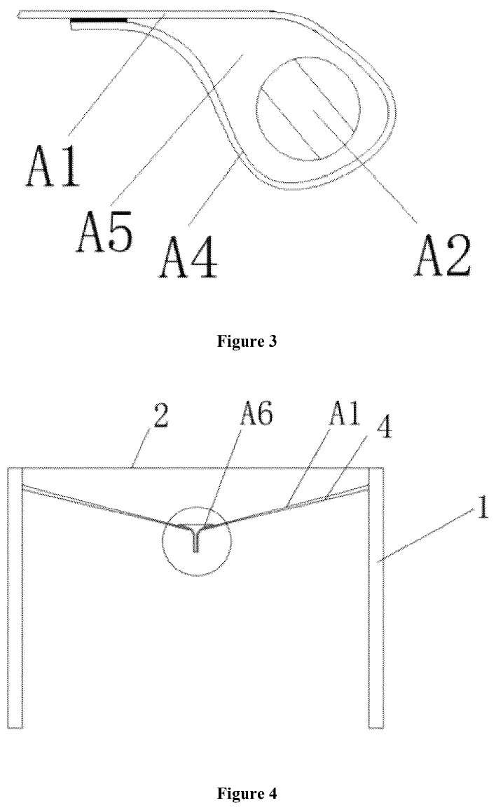

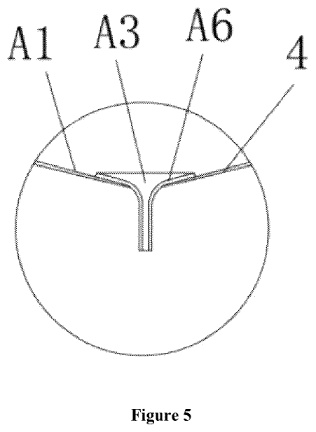

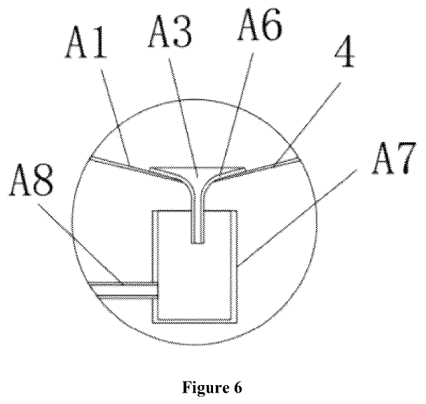

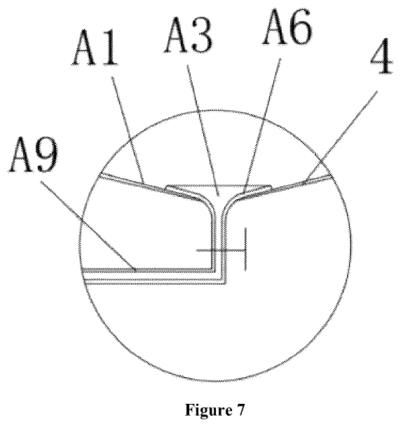

The upper ends of adjacent columns are fixed with cables (2) to form square cable grids (3), as shown in FIGS. 1 and 2. Fifty such grids are created, making the structure sturdy and wind-resistant.

A square greenhouse film with support rods along its edges is installed over the cable grids. The film includes a drainage hole (A3) at its center for rainwater collection, connected to a water-collecting funnel and bucket, which causes the film to sag slightly inwards. To prevent excessive sagging, sag-limiting ropes are attached from the corners of the film to the funnel, creating a stable drainage setup with controlled sagging.

The film may be made from canvas, tarpaulin, oilcloth, or plastic, while the support rods can be metal, plastic, or fiberglass.

The film's edges have hemmed strips forming channels for the support rods. These rods may be equal to the film's edges in length or half that length.

To prevent excessive sagging, the sag-limiting ropes are attached from the corners of the film to the funnel, supporting both the film and the suspended bucket. The rope lengths are slightly longer than half the distance between diagonal columns.

For efficient water drainage and collection, a conical funnel is attached to the drainage hole with a collection bucket below, which may have a side or bottom drainage pipe with a switch valve.

Construction of the greenhouse on-site involves fixing the galvanized steel pipe columns at set intervals in a square arrangement, securing them with cables at the top, and installing the square film with its central drainage funnel and collection bucket, thereby creating a stable, durable, rainproof greenhouse with controlled water drainage.

Using the example of constructing a greenhouse covering 1,800 square meters, referring to FIG. 1:

Step 1: On a 60-meter by 30-meter plot, erect 66 galvanized steel pipe columns (1) vertically at 6-meter intervals. The upper ends of the columns are fixed with cables, forming 50 cable grids, each covering an area of 36 square meters.

Step 2: Install the square greenhouse films with support rods (A2) along the edges onto each cable grid (each film covers 36 square meters). Attach a water-collecting funnel (A6) and collection bucket (A7) at the central drainage hole of each film. The collection bucket (A7) has an overflow outlet with an attached drainage pipe.

Step 3: Since the water-collecting funnel is positioned at the center of each square film, the weight of the rainwater in the collection bucket (A7) causes the 36-square-meter film to sag into a conical shape, facilitating drainage. To prevent excessive sagging and potential tearing, attach the upper ends of four sag-limiting ropes (4) from the corners of the square film to the corresponding steel pipe columns (1), connecting their other ends to the water-collecting funnel (A6). These ropes support the film from below and suspend the water-collecting funnel and bucket in midair, achieving a stable, controlled sag that promotes smooth drainage and resists damage.

### Installation and Effect of Individual Square Film

Due to the plastic greenhouse film's elasticity, each film should be slightly smaller than the cable grid. When installing, adjacent film support rods press against the cables, secured tightly by clip-on bindings to form a taut, drum-like surface. After attaching the water-collecting funnel and bucket at the center of each film, the difference in height between the funnel surface and the cable height creates a central dip, forming a conical surface with the highest edges and lowest center.

To control sagging, attach the sag-limiting ropes to the top ends of the corresponding steel pipe columns. These ropes support the film from below and suspend the funnel and bucket, achieving smooth, controlled drainage and realizing the core purpose of the invention.

In practical applications, if there is no need for water storage, the collection bucket can be omitted, with the funnel connected directly to a drainage pipe. A weighted object, such as a sandbag, can be suspended from the funnel, or it may be anchored with ropes to ground stakes, creating a similar controlled sag for efficient drainage.

The above detailed description further clarifies the purpose, technical solution, and beneficial effects of the invention. It should be understood that the foregoing embodiments are illustrative and not restrictive. Any modifications, equivalent replacements, or improvements made within the spirit and principles of the invention should fall within the scope of protection of this invention.

1. A non-arch-shaped rainproof water-collection greenhouse, comprising:
a matrix of galvanized steel pipe columns (1) arranged upright;
wherein the upper ends of adjacent galvanized steel pipe columns (1) are fixed by traction with cables (2);
the matrix arrangement of galvanized steel pipe columns (1) and cables (2) forms cable grids (3);
a square greenhouse film, with support rods along its edges, installed on said cable grids (3);
a drainage hole (A3) at the center of the square greenhouse film for discharging rainwater;
wherein a water-collecting funnel (A6) and a collection bucket (A7) are installed at the drainage hole (A3), causing the square greenhouse film within the cable grid to sag into a conical shape toward the center;
wherein the upper ends of the galvanized steel pipe columns (1) at the four corners corresponding to the square greenhouse film (A) are connected to the first ends of sag-limiting ropes (4);
the second ends of the sag-limiting ropes (4) are connected to the water-collecting funnel (A6);
wherein the sag-limiting ropes (4) support the square greenhouse film from below and suspend the collection bucket (A7) in midair.

2. The non-arch-shaped rainproof water-collection greenhouse of claim 1, wherein the edges of the square greenhouse film are equipped with hemmed strips (A4) that fold back toward the center of the square greenhouse film, with the edges of the hemmed strips sewn to the square greenhouse film to form channels (A5) for inserting the support rods.

3. The non-arch-shaped rainproof water-collection greenhouse of claim 1, wherein the square greenhouse film (A1) is made of canvas, tarpaulin, oilcloth, or plastic film; and the support rods (A2) are made of metal, plastic, or fiberglass.

4. The non-arch-shaped rainproof water-collection greenhouse of claim 1, wherein the drainage hole (A3) is connected to a water-collecting funnel (A6) in a conical shape, with the lower wall of the funnel's upper opening adhesively attached to the edge of the drainage hole.

5. The non-arch-shaped rainproof water-collection greenhouse of claim 4, wherein the lower opening of the water-collecting funnel (A6) connects to a collection bucket (A7), with a first drainage pipe (A8) attached to the side of the collection bucket; or a second drainage pipe (A9) with a switch valve attached to the lower opening at the bottom of the collection bucket (A7).
